(19) United States
(12) Patent Application Publication
(10) Pub. No.: US 2012/0303747 A1
(43) Pub. Date: Nov. 29, 2012

(54) TRANSMISSION METHOD ON THE UPLINK OF AN AIRCRAFT

(75) Inventors: Luc EMBERGER, Corronsac (FR); Julie Facon, Lauzerville (FR); Lucas Babelaere, Bondues (FR); Christian Turpaud, Fonsorbes (FR); Sebastien Delautier, Tournefeuille (FR)

(73) Assignee: AIRBUS OPERATIONS (Societe par Actions Simplifiee), Toulouse (FR)

(21) Appl. No.: 13/477,301

(22) Filed: May 22, 2012

(30) Foreign Application Priority Data
May 24, 2011 (FR) 11 54496

(51) Int. Cl. G06F 15/16; H04W 80/00

(52) U.S. Cl. 709/217

(57) ABSTRACT

A method for transmitting data, between an on-board segment on board an aircraft and on the ground, via a plurality of access networks. The on-board segment transmits to the ground information providing the association between the access networks and the corresponding IP addresses of the aircraft via these different networks. This information is used by a segment on the ground to make up and update a look-up table between identifiers of the access network and IP addresses of the aircraft. For transmitting a packet on the uplink, the recipient IP address is selected from IP addresses appearing in the look-up table.

### TECHNICAL FIELD

The present invention generally relates to the field of aeronautical telecommunications and more particularly to that of transmission of IP packets between an on-board segment and the ground.

### STATE OF PRIOR ART

Aircrafts communicate with the ground thanks to a datalink. This link in particular enables the exchange of AOC type (Aeronautical Operational Control) information with operators of airlines or ATC (Air Traffic Control) type information with the air traffic controllers, generally in the form of ACARS (Aircraft Communications Addressing and Reporting System) messages.

Conventionally, ACARS messages are transmitted according to the ARINC 618 protocol. However, with the boom of the aeronautical communications volume, it is contemplated to route data according to the TCP/IP protocol. For example, the application FR-A-2920622 filed on behalf of the present applicant describes a method for transmitting ACARS messages by encapsulation into IP packets, according to a protocol called ACARS over IP or AoIP.

The datalink can use several transmission media (or even called air-ground media or segments), that is several types of access networks for transmitting data, for example the HF, VDL (VHF Data Link) or SATCOM networks. It has been recently proposed to use consumer transmission media when the aircraft taxies or is parked on the ground or even when it is in the approach phase. For example, the aircraft can establish a connection by wireless link with the operating centre of the airline via the GPRS or UMTS network, a Wi-Fi terminal or even a Wi-Max station.

These transmission media have very different conditions of use and communication costs. Thus, the VHF telecommunication network allows point to point links in direct line of sight with transceivers on the ground but with a relatively reduced range. The satellite telecommunication network SATCOM on the other hand provides a global coverage, except for polar zones, but with high communication costs. The HF network itself enables polar zones to be covered. Finally, the consumer transmission media have a coverage restricted to the approach zones of some airports but have low communication costs. When an on-board application is to transmit to the ground, it is desirable to select the most suitable transmission media as a function of different criteria such as the network availability, cost, reliability, rate, etc. For example, application FR-A-2922397, filed on behalf of the present applicant describes a system for routing ACARS messages selecting a transmission medium depending on a number of routing profiles. A routing profile indicates for a given application, or a type of message to be transmitted by the application, the access networks usable for transmission and their respective degrees of preference.

FIG. 1 represents an aeronautical communication system implementing a transmission by IP packets and a routing by selection of the transmission medium.

This system includes an on-board segment 110, a plurality of air-ground segments 120 and a segment on the ground 130.

The on-board segment the aircraft generally includes a plurality of applications 111 hosted by calculators. These applications can have to transmit messages to the ground, for example to the operating centre of the airline as represented herein in 135, or even with a control tower. The messages considered are transmitted in the form of IP packets, possibly by encapsulation as mentioned above.

The IP packets are routed by the router 115 to different air-ground segments 120. The routing is performed under the control of the controller 117 from routing profiles stored in the database 113. For a given type of message and a given geographical zone, the controller 117 recovers the corresponding routing profile and determines the access network 120 on which the IP packets of this message should be transmitted.

It will be understood that the router 115 carries out the interface between the on-board network and the access networks 120. Thus, the router 115 has as many IP addresses as access networks to which it is connected: X₁ for the access network 1, X₂ for the access network 2, . . . X_{N} for the access network N.

Access providers 131 enable an IP (public or private) network to be accessed, 133, for example the Internet network. IP packets transmitted by the applications 111 and routed on any of the access networks 120 are then routed through the IP network to their final destination, herein the data centre 135 of the airline. In the illustrated case, the IP packets (routing messages) of the application 1 are preferentially routed via the access network 1 and failing that, on the network 2 as illustrated; IP packets (routing messages) of the application P can only be routed via the access network N. IP packets of the applications 1 to P can then be routed via the IP network to the data centre 135.

The access provider of the network 1 assigns an IP address X₁ to the aircraft. Once the link is established, the ground infrastructure updates its routing tables and the aircraft is reachable at the IP address X₁. The same is true for the access providers to the networks 2, . . . , N. The data centre of the airline can consequently reach the aircraft at any IP address but on the other hand does not know to which transmission media these addresses correspond.

Upon transmitting to the aircraft, the selection of the IP address (X₁, . . . , X_{N}) can only be made based on a conventional routing criterion, for example the number of hops which is not necessarily relevant. The access network associated with the IP address is unknown to the segment on the ground. Thus, an application hosted in the data centre could transmit a non priority high volume file to the address X₁, consequently via the access network 1 (for example SATCOM), whereas the same can turn out to be unsuitable for this kind of transfer in terms of costs, rate, reliability, availability, etc.

It is currently not possible to select a given transmission medium on the uplink from IP addresses of the aircraft. More generally, the selection of transmission media based on the above mentioned criteria is only possible on the downlink since the controller 117 takes the initiative in establishing the communication and performs said selection autonomously.

The purpose of the present invention is consequently to provide an aeronautical communication system enabling a relevant selection of the access network to be performed on the uplink.

### DESCRIPTION OF THE INVENTION

The present invention is defined by a method for transmitting data, in the form of IP packets, between a communication system segment on-board an aircraft and a segment on the ground, by means of a plurality of access networks, said on-board segment being connected to said plurality of access networks and having a same plurality of IP addresses, each IP address corresponding to one access network. According to the method concerned, information of association between at least one access network and said corresponding IP address is transmitted by the on-board segment to the segment on the ground.

According to a first alternative, the IP packets comply with the IPv6 protocol and the “flow label” field of at least one IP packet contains one identifier of the access network on which it is transmitted.

According to a second alternative, the IP packets comply with the IPv6 protocol and the “Next_Header” field of at least one IP packet contains a pointer to a header specific to a protocol encapsulated in the payload of said IP packet, said specific header being followed by an identifier of the access network on which said IP packet is transmitted.

Advantageously, the recipient of said IP packet updates a look-up table containing for each aircraft, and for each access network, the IP address of the on-board segment said aircraft for said access network.

According to a third alternative, the on-board segment transmits to the segment on the ground a message containing at least one couple consisting of an identifier of an access network of said plurality and the corresponding IP address of the on-board segment for this network.

In this case, the recipient of said message advantageously updates a look-up table containing for each aircraft, and for each access network, the IP address of the on-board segment said aircraft for said access network.

Regardless of the alternative used, the segment on the ground selects an access network for transmitting an IP packet to an on-board segment and the recipient address of this IP packet is obtained from said look-up table depending on the identifier of thus selected access network.

The recipient address of said IP packet is advantageously obtained from said look-up table depending on an identifier of the aircraft on board of which is located the on-board segment and on the identifier of the selected access network.

When the IP packet to be transmitted to the on-board segment is emitted by an application hosted in a calculator on the ground, the access network used for transmitting this packet is selected depending on the routine profile of said application.

The routing profile of said application can contain a classification of different access networks according to a preference order, the selected access network corresponding to the highest preference order for which an IP address of said on-board network is present in the look-up table.

### BRIEF DESCRIPTION OF THE DRAWINGS

Further characteristics and advantages of the invention will appear upon reading a preferential embodiment of the invention in reference to the appended figures wherein:

FIG. 1 schematically illustrates an exemplary aeronautical communication system known to the state of the art;

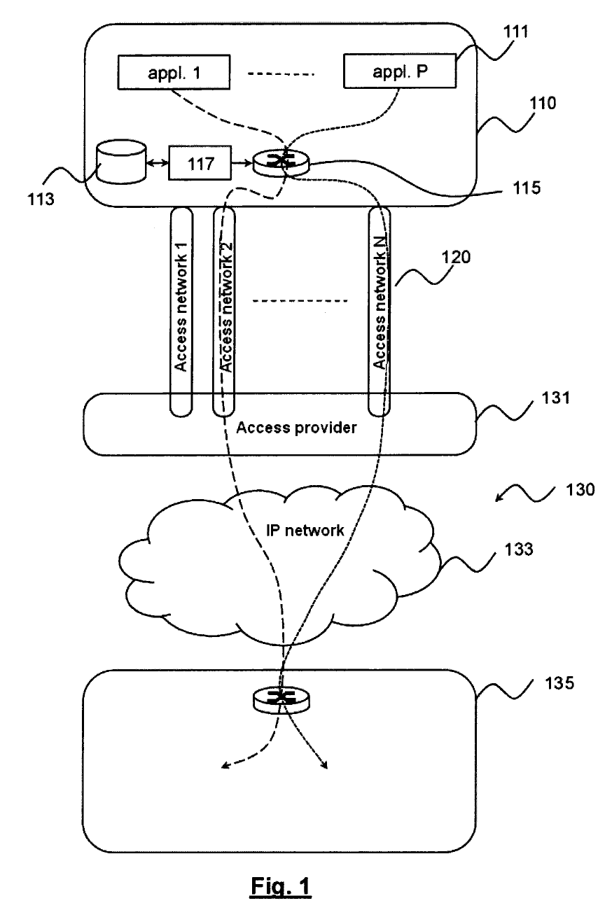

FIG. 2A schematically represents the operating mode on the downlink of an aeronautical communication system according to an embodiment of the invention;

FIG. 2B schematically represents the operating mode on the uplink of an aeronautical communication system according to an embodiment of the invention.

### DETAILED DESCRIPTION OF PARTICULAR EMBODIMENTS

It will be considered again an aeronautical communication system including an on-board segment 210, a segment on the ground 230 and a plurality of air-ground segments 220, consisting of different types of transmission media such as SATCOM, HF, VDL, GPRS, UMTS, Wi-Fi, Wi-Max, this list being only given by way of illustration and in no way limiting.

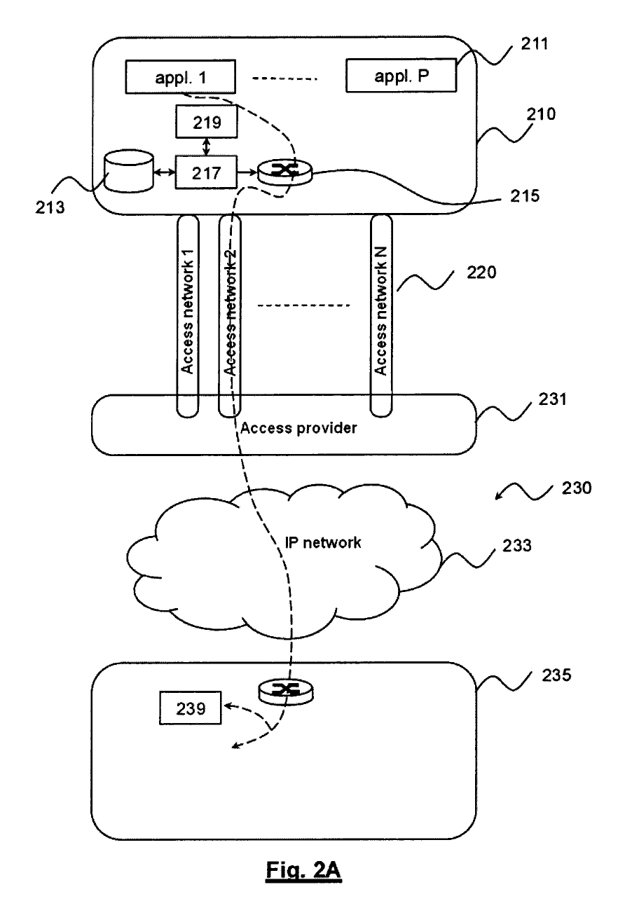

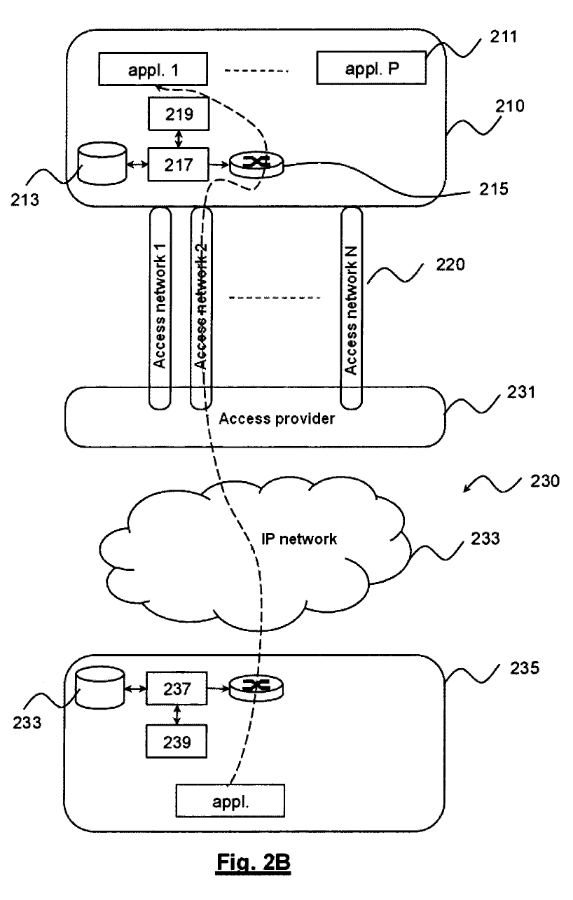

FIG. 2A illustrates the operation on the downlink of an aeronautical communication system according to an embodiment of the invention.

Applications 211 hosted by calculators on board the aircraft can transmit data in the form of IP packets on the downlink, for example the data centre of the airline 235. After communications have been established via the different transmission media 220, the interface router 215, in other words the on-board segment or the aircraft, has an IP address per access network as described above. For each access network, an IP address is assigned to the router interface connected to this network, upon establishing the connection.

Then, an association is performed between each access network and the thus assigned IP address. Since each access network is characterised by a single identifier, this association is reflected by a couple (access network identifier, IP address of the interface router on this network), noted (id(acc_net),IP_add). The identifier can be a series of alphanumeric characters and the corresponding IP address can be coded according to the IPv6 format or the IPv4 format. The couples (id(acc_net),IP_add) are preferably stored in a first look-up table 219, to which the controller 217 can access.

It will be understood that the interface router, in other words the on-board segment, has as many IP addresses available as the number of access networks it uses on the downlink. According to the principle of the invention, the on-board segment transmits to the segment on the ground association information between at least one access network and the IP address of the aircraft for this network.

This information can be transmitted in different ways.

According to a first alternative using the IPv6 protocol, the IP packets transmitted on the downlink can contain in the “Flow label” field of their header, the identifier of the access network on which they are transmitted. It is reminded that the IPv6 protocol has been specified in document RFC 2460. Headers of IP packets complying with this protocol include a flow reference field called “Flow label”, the specification of which could be found in document RFC 3697. The “Flow label” field is for indicating the flow to which the packet belongs. More precisely, for a given packet, the flow to which it belongs can be identified from the source address of the packet, its recipient address as well as the flow reference, all of the three information are present in the header of the IPv6 packet. The “Flow label” field can be indicated by the controller 217.

For example, if an application is to use the SATCOM network to transmit a message to the ground, the IP packets routing this message will all include in the “Flow label” field, the identifier Id(SATCOM). The source IP address on these packets will be for example in the form router_address:calculator_address, where “router_address:0” is the IP address of the interface router on the access network and “calculator_address” is the suffix giving the address of the calculator hosting the application. The recipient of these packets will then be able to associate the aircraft address “router_address:0” to the SATCOM network.

According to a second alternative, the IP packets transmitted on the downlink can contain a specific header. The IPv6 header of these packets actually includes a field called “Next-Header” pointing to the following header, related to a protocol encapsulated in the payload of the packet, cf. RFC 3697 abovementioned. It is proposed herein to define as the following header, a specific header indicating that the PDU (Protocol Data Unit) of this protocol contains the identifier of the access network used by the packet. From the packet contents, the access network can then be associated with the IP address of the on-board segment (that is on-board the aircraft) and update the look-up table 239.

In both previous alternatives, the association information between the access network and the IP address of the on-board segment is typically transmitted for each IP packet. It will however be understood that it can only be transmitted by some packets.

According to a third alternative, that can be employed both for the IPv4 protocol and the IPv6 protocol, the association information is transmitted by means of a specific association message. This specific message preferably contains a couple consisting of the identifier of an access network.

Preferably, this message is transmitted when the interface router is connected to an access network. It can then be transmitted at regular intervals to indicate to the recipient that this association is still valid. The message can be sent in multicast mode to a predetermined set of recipients such as the operating centre of the airline or aircraft controllers. Upon receiving the message, the association information enables the look-up table 239 to be updated.

Regardless of the alternative contemplated, the segment on the ground can thus know to which access network corresponds any IP address of the aircraft.

In the example represented in FIG. 2, IP packets from an on-board application are transmitted to the operating centre of the airline (AOC). The association information received from the aircraft is used to update the look-up table 239. This table contains, for each access network, the corresponding IP address of the aircraft. Generally, the operating centre simultaneously manages a great number of aircrafts and the table consequently includes, for each of them, a list of access networks with the corresponding IP addresses. For example, each recording of the look-up table 239 can have the following form:

|id(aircraft)|id(acc_net)|IP_add|

In which id(aircraft) is the identifier of an airline aircraft, id(acc_net) is the identifier of an access network and IP add is the IP address enabling said aircraft to be accessed via said access network.

This look-up table can be updated upon receiving each IP packet received from an aircraft, in the case of the first and second alternatives, wherein the updating can then be directly performed by a primitive of the network layer. Besides, in the case of the third alternative, the updating is performed upon receiving a specific association message by the applicative layer, an association information being considered as being valid as long as it has not been updated by such a specific message.

FIG. 2B illustrates the operation on the uplink of an aeronautical communication system according to an embodiment of the invention.

It is assumed that the second look-up table 239 has been made up and updated beforehand, as set out above. It is also assumed that the operating centre includes a second database 233 wherein the routing profiles are stored. A routing profile, relating to a given application or a type of message, gives the different types of access networks which can be used by the application (or for the message) as well as, if need be possibly, their respective preference orders.

When an application hosted by the operating centre is to transmit a message to an application of the aircraft, the recipient IP address is selected depending on a routing profile stored in a database 233 and the second look-up table 239. This IP address can be selected by the calculator hosting the application concerned. Alternatively, the calculator can only have access to a generic address of the aircraft and the controller 237 substitutes the most suitable IP address for it, from the routing profile of the application and recordings relating to this aircraft which are stored in the second look-up table.

For example, if an application is to transmit an important low priority file to the aircraft, the routing profile stored in the base 233 could indicate a preference for using the GPRS network. If the second look-up table includes a recording for this aircraft with an IP address via the GPRS network, which could be the case for example if the aircraft is parked on the ground, the IP address chosen would be that appearing in this recording.

Conversely, if the message has priority, the routing profile stored in the base 233 could indicate a preference for using the second network. The IP address chosen would be then that appearing in the recording relating to that aircraft and to the SATCOM network in the second look-up table.

It is thus understood that, thanks to the invention, the transmission media could be selectively used on the uplink, depending on criteria of cost, rate, reliability, availability, etc. in the same way as on the downlink.

1. A method for transmitting data, in the form of IP packets, between a communication system segment on-board an aircraft and a segment on the ground, with a plurality of access networks, said on-board segment being connected to said plurality of access networks and having a same plurality of IP addresses, each IP address corresponding to one access network, wherein association information between at least one access network and said corresponding IP address is transmitted by the on-board segment to the segment on the ground.

2. The method for transmitting data according to claim 1, wherein the IP packets comply with the IPv6 protocol and a flow label field of at least one IP packet contains one identifier of the access network on which said IP packet is transmitted.

3. The method for transmitting data according to claim 1, wherein the IP packets comply with the IPv6 protocol and that a Next_Header field of at least one IP packet contains a pointer to a header specific to a protocol encapsulated in the payload of said IP packet, said specific header being followed by an identifier of the access network on which said IP packet is transmitted.

4. The method for transmitting data according to claim 2, wherein the recipient of said IP packet updates a look-up table containing for each aircraft, and for each access network, the IP address of the on-board segment said aircraft for said access network.

5. The method for transmitting data according to claim 1, wherein the on-board segment transmits to the segment on the ground a message containing at least one couple consisting of an identifier of an access network of said plurality and the corresponding IP address of the on-board segment for this network.

6. The method for transmitting data according to claim 5, wherein the recipient of said message updates a look-up table containing for each aircraft, and for each access network, the IP address of the on-board segment said aircraft for said access network.

7. The method for transmitting data according to claim 4, wherein the segment on the ground selects an access network for transmitting an IP packet to an on-board segment and that the recipient address of this IP packet is obtained from the look-up table depending on the identifier of thus selected access network.

8. The method for transmitting data according to claim 7, wherein the recipient address of said IP packet is obtained from said look-up table depending on an identifier of the aircraft on board of which is located the on-board segment and on the identifier of the selected access network.

9. The method for transmitting data according to claim 7, wherein said IP packet to be transmitted to the on-board segment is emitted by an application hosted in a calculator on the ground, and the access network used for transmitting this packet is selected depending on the routine profile of said application.

10. The method for transmitting data according to claim 9, wherein the routing profile of said application contains a classification of different access networks according to a preference order, the selected access network corresponding to the highest preference order for which an IP address of said network on board is present in the look-up table.
